(19) United States
(12) Patent Application Publication
(10) Pub. No.: US 2020/0099029 A1
(43) Pub. Date: Mar. 26, 2020

(54) BATTERY BOX

(71) Applicant: CONTEMPORARY AMPEREX TECHNOLOGY CO., LIMITED, Ningde (CN)

(72) Inventors: Jie DU, Ningde (CN); Lin Ma, Ningde (CN)

(21) Appl. No.: 16/562,124

(22) Filed: Sep. 5, 2019

(30) Foreign Application Priority Data
Sep. 20, 2018 (CN) 201821544482.7

(51) Int. Cl. H01M 2/10

(52) U.S. Cl. CPC H01M 2/1094; H01M 2220/20; H01M 2/1072

(57) ABSTRACT

The present disclosure provides a battery box, which comprises: a lower box body; an upper box body covering the lower box body; a battery module received in the lower box body and the upper box body; and a protecting member positioned above the battery module and covering at least the upper surface of the battery module to prevent high temperature drips formed by accidental combustion of the upper box body above the battery module from dropping onto the battery module. The protecting member of the battery box according to the present disclosure effectively blocks the high temperature drips formed by the accidental combustion of the upper box body of the battery box dropping onto the battery module, and reduces the risk of combustion and explosion of the battery module.

### CROSS-REFERENCE To RELATED APPLICATIONS

The present application claims priority to Chinese patent application No. CN201821544482.7, filed on Sep. 20, 2018, which is incorporated herein by reference in its entirety.

### FIELD OF THE PRESENT DISCLOSURE

The present disclosure relates to the field of battery, and particularly relates to a battery box.

### BACKGROUND OF THE PRESENT DISCLOSURE

At present, electric automobiles mainly use a battery module with a high voltage as a power source. In the process of use, when a secondary battery of the battery module is affected by factors, such as short-circuit, high temperature and the like, the secondary battery is prone to generate high-pressure gas therein, in turn, it is prone to cause thermal runaway, result in accidents such as combustion and explosion.

Generally, in the electric automobiles, the battery module needs to be placed in a battery box, and an upper box body of the battery box is usually made of LFT (long fiber reinforced thermoplastic) composites, blister PP (polypropylene) or ultra-thin aluminum alloy. However, when the battery box comprising this upper box body is subjected to the external fire, the upper box body will burn and melt, and the high temperature drips formed by the burning and melting of the upper box body will drop on the secondary battery of the battery module, thus the high temperature drips may cause the risk of combustion and explosion of the secondary battery.

### SUMMARY OF THE PRESENT DISCLOSURE

In view of the problem exiting in the background, an object of the present disclosure is to provide a battery box, which can avoid high temperature drips formed by the accidental combustion of the upper box body of the battery box dropping onto the battery module, and reduce the risk of the combustion and explosion of the secondary battery.

In order to achieve the above object, the present disclosure provides a battery box, which comprises: a lower box body; an upper box body covering the lower box body; a battery module received in the lower box body and the upper box body; and a protecting member positioned above the battery module and at least covering the upper surface of the battery module to prevent high temperature drips formed by accidental combustion of the upper box body above the battery module from dropping onto the battery module.

The protecting member comprises a support layer and a refractory protective layer.

The support layer and the refractory protective layer each are provided as one layer, and the refractory protective layer faces the upper box body, the support layer is positioned between the refractory protective layer and the battery module and secured on the battery module.

The refractory protective layer is a mica layer.

The refractory protective layer is a ceramized silicone rubber layer.

The support layer is a fiber cloth layer.

The protecting member further comprises a binder which bonds the refractory protective layer together with the support layer.

A thickness of the protecting member is from 0.13 mm to 0.18 mm; a thickness of the support layer is from 0.02 mm to 0.05 mm; a thickness of the binder is from 0.01 mm to 0.02 mm.

The protecting member further covers at least a part of a side of the battery module.

The protecting member extends to a side of the battery module and forms a closed annular receiving groove.

The present disclosure has the following beneficial effects: the protecting member of the battery box according to the present disclosure effectively blocks the high temperature drips formed by the accidental combustion of the upper box body of the battery box dropping onto the battery module, and reduces the risk of combustion and explosion of the battery module.

### BRIEF DESCRIPTION OF THE FIGURES

FIG. 1 is a schematic view of an embodiment of a battery box according to the present disclosure.

FIG. 2 is a schematic view of another embodiment of the battery box according to the present disclosure.

FIG. 3 is an enlarged view of the structure of a protecting member.

Reference numerals are represented as follows:
1 lower box body
2 upper box body
3 battery module
31 secondary battery
32 insulating cover
4 protecting member
41 support layer
42 refractory protective layer
43 receiving groove
5 safety vent
6 fixing bolt

### DETAILED DESCRIPTION

The appended figures illustrate an embodiment of the present disclosure and it is to be understood that the disclosed embodiment is merely exemplary of the disclosure, which may be embodied in various forms. Therefore, specific details disclosed herein are not to be interpreted as limiting, but merely as a basis for the claims and as a representative basis for teaching one skilled in the art to variously employ the present disclosure.

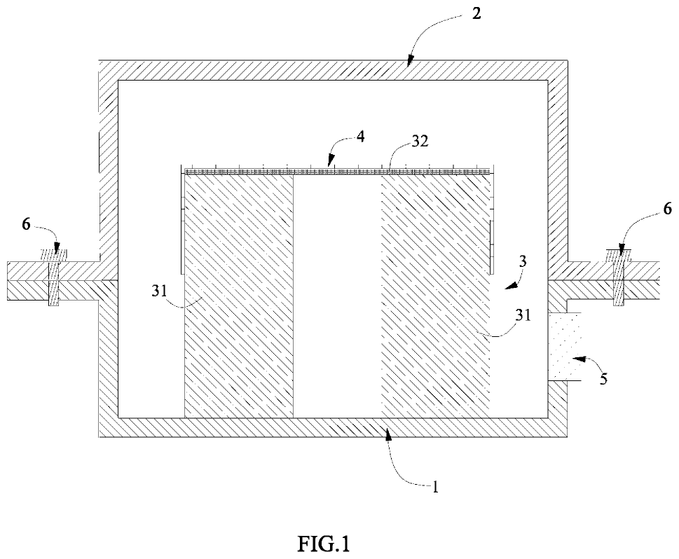

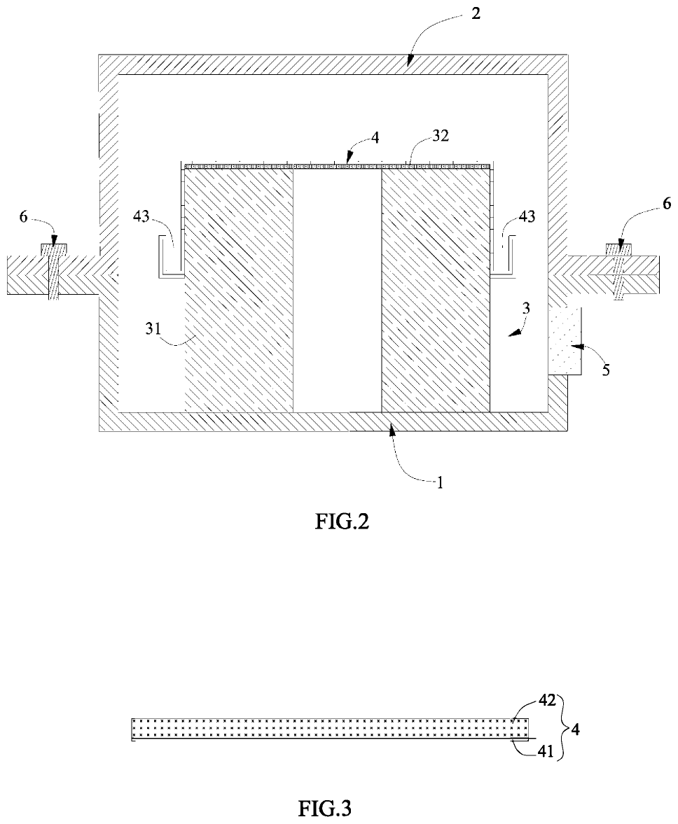

FIG. 1 is a schematic view of an embodiment of a battery box according to the present disclosure. FIG. 2 is a schematic view of another embodiment of the battery box according to the present disclosure.

A battery box according to the present disclosure comprises: a lower box body 1, an upper box body 2, a battery module 3 and a protecting member 4. The battery box further comprises a safety vent 5 and a fixing bolt 6.

The upper box body 2 covers the lower box body 1. The lower box body 1 is made of metal, preferably aluminum alloy. The upper box body 2 can be made of aluminum alloy, LFT (long fiber reinforced thermoplastic) composites or polypropylene.

The battery module 3 is received in the lower box body 1 and the upper box body 2. The battery module 3 comprises: a plurality of secondary batteries 31; and an insulating cover 32 fixed above the plurality of secondary batteries 31. The insulating cover 32 is usually made of plastic.

The protecting member 4 is positioned above the battery module 3 and at least covers an upper surface of the battery module 3 to prevent high temperature drips formed by accidental combustion of the upper box body 2 above the battery module 3 from dropping onto the battery module 3.

The safety vent 5 may be provided on a side surface of the lower box body 1. Of course, it is not limited thereto. The safety vent 5 may further be provided on a side surface of the upper box body 2. The position can be provided according to the specific situation.

The fixing bolt 6 fixes the upper box body 2 together with the lower box body 1.

When the battery box is subjected to the external fire, the upper box body 2 will burn and melt and form high temperature drips. If the high temperature drips drop directly onto the insulating cover 32 of the battery module 3 which is located below the upper box body 2, the insulating cover 32 will be burned through, which may cause the secondary battery 31 under the insulating cover 32 to be short-circuited, burn and explode. While in the battery box according to the present disclosure, the protecting member 4 is provided above the battery module 3 and at least covers the entire upper surface of the battery module 3, and the protecting member 4 has the properties of the high temperature and fire resistance, which effectively blocks the high temperature drips formed by the accidental combustion of the upper box body 2 of the battery box dropping onto the insulating cover 32 of the battery module 3, and avoids the high temperature drips burning through the insulating cover 32 and contacting the secondary battery 31, thereby reducing the risk of combustion and explosion of the battery module 3, enhancing the fire resistance function of the battery box.

FIG. 3 is an enlarged view of the structure of the protecting member.

The protecting member 4 comprises a support layer 41 and a refractory protective layer 42. The order that the support layer 41 and the refractory protective layer 42 are combined in the thickness direction of the protecting member 4 can be determined according to actual needs. For example, the one facing the upper box body 2 may be the refractory protective layer 42, or may be the support layer 41, and the one facing the battery module 3 may be the support layer 41 or the refractory protective layer 42, which is determined according to the number of layers provided by the support layer 41 and the refractory protective layer 42 and the order that the support layer 41 and the refractory protective layer 42 are combined in the thickness direction of the protecting member 4. The protecting member 4 may further form a receiving groove 43.

The support layer 41 and the refractory protective layer 42 each are provided as at least one layer.

The support layer 41 and the refractory protective layer 42 of the protecting member 4 have various combinations, preferably, in an embodiment, as shown in FIG. 3, the support layer 41 and the refractory protective layer 42 each are provided as one layer, and the refractory protective layer 42 faces the upper box body 2, the support layer 41 is positioned between the refractory protective layer 42 and the battery module 3 and secured on the battery module 3.

Of course, it is not limited thereto, and there are other combinations, that is, in another embodiment, the support layer 41 is provided as two layers, the refractory protective layer 42 is provided as one layer, and the refractory protective layer 42 is positioned between the two support layers 41.

In still another embodiment, the support layer 41 is provided as one layer, the refractory protective layer 42 is provided as two layers, and the support layer 41 is positioned between the two refractory protective layers 42.

In still another embodiment, the refractory protective layer 42 and the support layer 41 each are provided as two layers, and the refractory protective layers 42 and the support layers 41 are alternately arranged in the thickness direction.

In the above various embodiments, on the basis of ensuring the fire resistance property, the refractory protective layer 42 and the support layer 41 each are provided as one layer in order to reduce the overall weight of the battery box and increase the energy density of the battery box.

The support layer 41 is a fiber cloth layer. Specifically, a material of the fiber cloth layer is selected from one of a group consisting of glass fiber, carbon fiber and aramid fiber. Preferably, the material of the fiber cloth layer is fiberglass cloth.

The refractory protective layer 42 may be a mica layer. Preferably, the mica layer is a phlogopite layer. The phlogopite layer comprises a plurality of mica papers laminated together and a binder which binds every two adjacent mica papers (not shown) together. The binder is selected from methylphenyl silicone resin or acrylic adhesive. The methylphenyl silicone resin or the acrylic adhesive is soft adhesive, which can ensure the structural integrity between mica papers on the one hand, and ensure that the protecting member 4 can be folded freely and the adjacent mica papers are not separated from each other on the other hand. Due to the low strength and brittleness of the mica paper, the fiber cloth provides sufficient anti-tear strength for the mica paper, so that the mica paper can resist the gravity impact of the high temperature drips, thereby effectively providing the fire resistance property.

The refractory protective layer 42 can also be a ceramized silicone rubber layer. The mica layer or the ceramized silicone rubber layer has high temperature resistance and can prevent from being burned by the high temperature drips, thereby effectively blocking the high temperature drips from burning through the insulating cover 32 of the battery module 3 to cause the risk of the secondary battery 31 being burned and exploded.

It should be noted that the combination of the support layer 41 and the refractory protective layer 42 and the specific material combination of the support layer 41 and the refractory protective layer 42 can be selected according to the best fire resistance test results, so as to achieve the best fireproof effect.

The material of the protecting member 4 is lighter in weight and lower in cost in comparison with the fire-resistant heat-isolating cloth added in the box (the upper box body 2 and the lower box body 1) in the prior art.

The protecting member 4 further comprises a binder (not shown) which bonds the refractory protective layer 42 together with the support layer 41. The binder is selected from methylphenyl silicone resin or acrylic adhesive. The methyl-phenyl silicone resin or the acrylic adhesive is a soft adhesive, which ensures that the protecting member 4 can be folded freely and the refractory protective layer 42 is not separated from the support layer 41. The refractory protective layer 42, the binder, the support layer 41 form the protecting member 4 by pressing.

A thickness of the protecting member 4 is from 0.13 mm to 0.18 mm, preferably is 0.15 mm. A thickness of the support layer 41 is from 0.02 mm to 0.05 mm, preferably is 0.04 mm. A thickness of the binder which bonds the refractory protective layer 42 together with the support layer 41 is from 0.01 mm to 0.02 mm. The thickness of the protecting member 4 is controlled within a certain range, which can effectively reduce the overall weight of the battery box, increase the energy density of the battery box, and realize lightness of the battery box.

In an embodiment, the protecting member 4 further covers at least a part of the side of the battery module 3. Preferably, the protecting member 4 further covers the whole side of the battery module 3, so that when the high temperature drips drop onto a portion of the protecting member 4 covering above the battery module 3 and flow down from both sides of the protecting member 4, the protecting member 4 can avoid the side of the battery module 3 from contacting the high temperature drips, thereby improving the safety of the battery module 3.

In another embodiment, as shown in FIG. 2, the protecting member 4 further extends to the side of the battery module 3 and forms a closed annular aforementioned receiving groove 43. An inner side of the receiving groove 43 is a refractory protective layer 42. When the high temperature drips drop onto the portion of the protecting member 4 covering above the battery module 3 and flow down from both sides of the protecting member 4, the receiving groove 43 can receive the high temperature drips to prevent the high temperature drops from contacting the side of the battery module 3 and damaging the battery module 3.

The above detailed description describes various exemplary embodiments, but is not intended to be limited to the specifically disclosed combinations. Therefore, unless otherwise stated, the various features disclosed herein can be combined together to form a plurality of additional combinations that are not shown for the sake of clarity.

What is claimed is:

1. A battery box, comprising:
a lower box body;
an upper box body covering the lower box body;
a battery module received in the lower box body and the upper box body; and
a protecting member positioned above the battery module and at least covering the upper surface of the battery module to prevent high temperature drips formed by accidental combustion of the upper box body above the battery module from dropping onto the battery module.

2. The battery box according to claim 1, wherein the protecting member comprises a support layer and a refractory protective layer.

3. The battery box according to claim 2, wherein the support layer and the refractory protective layer each are provided as one layer, and the refractory protective layer faces the upper box body, the support layer is positioned between the refractory protective layer and the battery module and secured on the battery module.

4. The battery box according to claim 2, wherein the refractory protective layer is a mica layer.

5. The battery box according to claim 2, wherein the refractory protective layer is a ceramized silicone rubber layer.

6. The battery box according to claim 2, wherein the support layer is a fiber cloth layer.

7. The battery box according to claim 2, wherein the protecting member further comprises a binder which bonds the refractory protective layer together with the support layer.

8. The battery box according to claim 7, wherein a thickness of the protecting member is from 0.13 mm to 0.18 mm; a thickness of the support layer is from 0.02 mm to 0.05 mm; a thickness of the binder is from 0.01 mm to 0.02 mm.

9. The battery box according to claim 1, wherein the protecting member further covers at least a part of a side of the battery module.

10. The battery box according to claim 1, wherein the protecting member extends to a side of the battery module and forms a closed annular receiving groove.

11. The battery box according to claim 1, wherein a thickness of the protecting member is from 0.13 mm to 0.18 mm.

12. The battery box according to claim 2, wherein a thickness of the support layer is from 0.02 mm to 0.05 mm.

13. The battery box according to claim 7, wherein a thickness of the binder is from 0.01 mm to 0.02 mm.

14. The battery box according to claim 2, wherein the refractory protective layer is a phlogopite layer.

15. The battery box according to claim 2, wherein the support layer is a fiberglass cloth layer.

16. The battery box according to claim 7, wherein the binder is methylphenyl silicone resin or acrylic adhesive.

17. The battery box according to claim 14, wherein the phlogopite layer comprises a plurality of mica papers laminated together and a binder which binds every two adjacent mica papers together.

18. The battery box according to claim 17, wherein the binder is methylphenyl silicone resin or acrylic adhesive.

19. The battery box according to claim 2, wherein the refractory protective layer faces the upper box body.

20. The battery box according to claim 2, wherein the support layer is positioned between the refractory protective layer and the battery module and secured on the battery module.
